(19) United States
(12) Patent Application Publication
(10) Pub. No.: US 2018/0090240 A1
(43) Pub. Date: Mar. 29, 2018

(54) ELECTRIC INSULATING MATERIAL, ELECTRIC INSULATING COATING COMPOUND AND ELECTRIC INSULATING WIRE HAVING EXCELLENT THERMAL CONDUCTION PERFORMANCE

(71) Applicant: TOTOKU TORYO CO., LTD., Tokyo (JP)

(72) Inventors: Toshimi KOGA, Honjo City (JP); Yuichi FUJIKURA, Honjo City (JP); Katsuhiko FUKUDA, Honjo City (JP); Shin JUNG-SHUN, Tokyo (JP)

(73) Assignee: TOTOKU TORYO CO., LTD., Tokyo (JP)

(21) Appl. No.: 15/715,570

(22) Filed: Sep. 26, 2017

(30) Foreign Application Priority Data
Sep. 28, 2016 (JP) 2016-189457

(51) Int. Cl. H01B 3/30; H01B 7/29; C08L 79/08; C09D 179/08

(52) U.S. Cl. CPC H01B 3/306; C09D 179/08; C08L 79/08; H01B 7/292

(57) ABSTRACT

An electric insulating material, an electric insulating coating compound used this material and an electric insulating wire used this coating compound having excellent thermal conduction performance (high thermal conductivity), said material, coating compound and wire comprised of a polyamideimide resin having repeating unit of 4,4′-stilbenedicarbonate group, specifically, wherein the polyamideimide resin comprised of amido bond of stilbenedicarboxylic acid represented by general formula (I). Said resin is useful for insulated coils of electric motors of solar car used solar batteries, and it is particularly excellent in thermal conduction performance, also excellent in heat resistance and the like, thermal conduction performance can be improved without using filler.

### TECHNICAL FIELD

The present invention relates to an electric insulating material, an electric insulating coating compound used this material and an electric insulating wire used this coating compound having excellent thermal conduction performance (high thermal conductivity), for further details, the present invention relates to the electric insulating material, the electric insulating coating compound used this material and the electric insulating wire used this coating compound having excellent thermal conduction performance (high thermal conductivity) comprised of a polyamideimide resin having a repeating unit of 4,4′-Stilbenedicarbonate group, specifically, a polyamideimide resin having an amido bond of a stilbenedicarboxylic acid.

### TECHNICAL BACKGROUND

A solar car of an automobile has a solar battery as an electric power supply, and the solar car of the automobile can be drove by the an electric motor.

In the solar car, an energy of a light from the sun changes into the electric energy, its power takes from said electric energy, and said electric energy feeds to an electric motor, then, the solar car can be drove by a tire turns over.

The electric motor of the solar car needs that it is lightweight and high-efficiency in order to make best use of the electric power of the solar battery.

The electric motor is an electrical equipment which the electric energy changes into a mechanical energy. The electric motor comprising a rotor, a stator which ingenerates a torque by interaction between the rotor, a rotary shaft which can transmit the revolution of the rotor for external, a bearing which can be support the rotary shaft and a cooling device which can cool off about the heat produced by dissipation.

There are many kinds in the electric motor, there is the electric motor which the insulating coil winds in the stator and a varying magnetic field ingenerates by feeding of changing electric current to said coil, said coil needs excellent performance of thermal conduction namely having excellent thermal conduction performance (having high thermal conductivity) in order to give out heat by using thereof.

In order to enhance said thermal conduction performance (thermal conductivity) of an electric equipment, the metal oxide and the thermally conductivity filler, for example, zinc oxide, beryllium oxide, zinc aluminum, aluminum nitride, nitriding boron, silicon oxide, aluminum powder, carbon black, micronized silica, bentonite, diamond were used in the past (Japan examined Patent Publication No. Showa 52-33272, Japan Unexamined Patent Publication No. Hei. 10-110179, Japan Unexamined Patent Publication No. 2004-91743, Japan Unexamined Patent Publication No. 2008-25538).

Said filler, as a FIGURE of the electric insulating coating compound (varnish), for example, as one FIGURE, the insulating coating compound comprised of styrene block copolymerization, tacky adhesion grant resin and solvent was used, wherein the insulating coating compound included the fillers, for example, the insulating coating compound included nitriding boron, silicon carbide, aluminum nitride, aluminum oxide, silicon nitride, silicon oxide, magnesium oxide, zinc oxide, or titanium oxide was offered (Japan Unexamined Patent Publication No. Hei. 11-246885, Japan Unexamined Patent Publication No. 2002-201483, Japan Unexamined Patent Publication No. 2008-174697, Japan Unexamined Patent Publication No. 2008-303263, Japan Unexamined Patent Publication No. 2008-222776).

However, on the other hand, when using of said filler, said filler muddy to the electric insulating coating compound, then, nevertheless said filler does not use, there was request for possibility of enhance of thermal conduction performance (thermal conductivity) by a constituent resin of the electric insulating coating compound.

Also, the insulating coil comprised of the electric insulating wire of the electrical equipment not only needs aforementioned appreciate of thermal conduction performance (thermal conductivity), but also in the motor and reactor (inductance) of aforementioned solar car, the coil needs excellent heat resistance performance (heat softening temperature) in high-temperature in view of resistance properties for high voltage specification by large current of motor and reactor in aforementioned solar car, also the self melting welding process makes at high temperature. Also, the insulated coil is required to have excellent flexibility which is its fundamental characteristic of not causing deterioration of the winding in use, and in order to prevent the service life of the electric device from being lowered, heat shock resistance, and the like are required.

### PATENT DOCUMENTS

Japan examined Patent Publication No. Showa 52-33272;

Japan Unexamined Patent Publication No. Hei. 10-110179;

Japan Unexamined Patent Publication No. 2004-91743;

Japan Unexamined Patent Publication No. 2008-255275;

Japan Unexamined Patent Publication No. Hei. 11-246885;

Japan Unexamined Patent Publication No. 2002-201483;

Japan Unexamined Patent Publication No. 2008-174697;

Japan Unexamined Patent Publication No. 2008-303263;

Japan Unexamined Patent Publication No. 2008-222776.

### Problems to be Solved by the Invention

It is therefore an object of the present invention to provide technical skill to eliminate the above-mentioned problems, and to provide technical skill can be reply the above-mentioned request.

In particular, the present invention aims to impart further excellent thermal conduction performance (high thermal conductivity) to a polyamide-imide resin which is excellent as an electrically insulating material having excellent heat resistance, and the like.

The foregoing and other objects and novel features of the present invention will become clear from the following description and the accompanying drawings.

### Means for Solving the Problems

The inventors of the present invention have found a resin constituting an electrically insulating material capable of improving thermal conduction performance (thermal conductivity) even when a filler is not used, particularly about a polyamide imide resin having excellent heat resistance and excellent electrical insulating performance, the present inventors have found that a resin having a repeating unit of 4,4′-stilbenedicarbonate is excellent in thermal conductivity, particularly, the present inventors have found that the polyamideimide resin having a repeating unit of an amide bond of a 4,4′-stilbene dicarboxylic acid amide and a repeating unit of an imide bond of a tetracarboxylic anhydride has excellent thermal conductivity and make clear the above objects.

That is, the present invention relates to the following matter.

(1) An electric insulating material having excellent thermal conduction performance (high thermal conductivity) comprising the polyamideimide resin having the repeating unit of 4,4′-stilbenedicarbonate group.

(2) The electric insulating material having excellent thermal conduction performance (high thermal conductivity) according to above item (1), wherein the polyamideimide resin is the polyamideimide resin expressed by a following general formula (I).

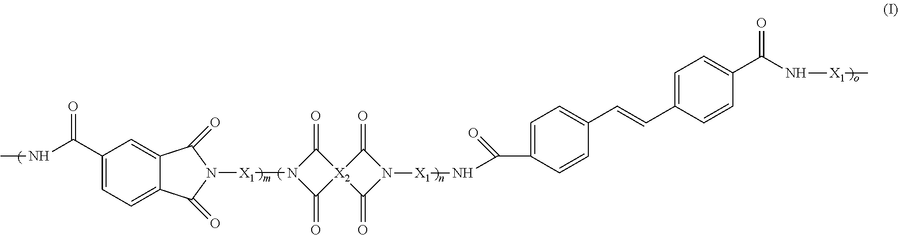

In the general formula (I), m, n, and o represent each number of the repeating unit, m is 0 or 1 to 95, n is 1 to 50, and o is 1 to 80.

Plural X₁ of the general formula (I) represent each independently at least one structural formula selected from the group consisting of a following structural formula (II), a following structural formula (III), a following structural formula (IV), a following structural formula (V), a following structural formula (VI), and a following structural formula (VII).

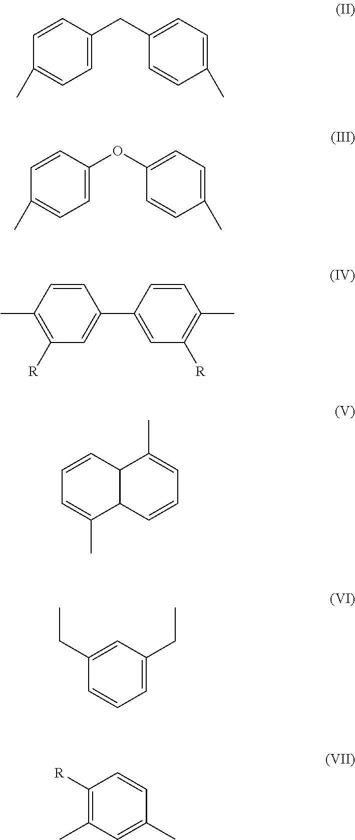

Plural X₂ of the general formula (I) represent each independently at least one structural formula selected from the group consisting of a following structural formula (VIII), a following structural formula (IX), a following structural formula (X), a following structural formula (XI), a following structural formula (XII), a following structural formula (XIII), a following structural formula (XIV), a following structural formula (XV), and a following structural formula (XVI).

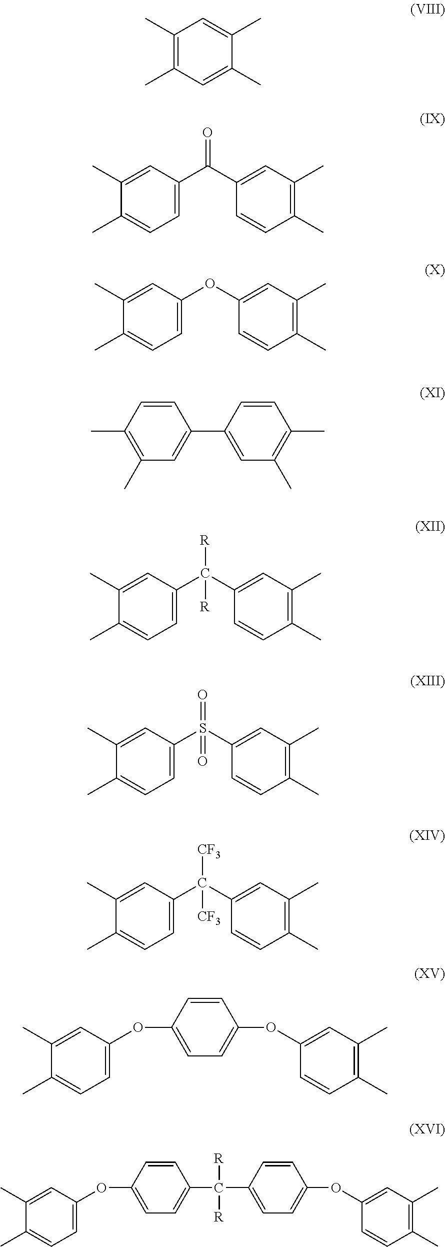

R of said structural formulas (IV), (XII), and (XVI) represent a hydrocarbon group.

(3) The electric insulating material according to above item (1), wherein the polyamideimide resin is a powdered polyamideimide resin.

(4) The electric insulating material according to above item (3), further comprising the polyamideimide resin added a ceramic powder.

(5) The electric insulating material according to above item (3), further comprising the polyamideimide resin added boron nitride, silicon carbide, aluminum nitride, or aluminum oxide.

(6) An electric insulating coating compound comprising at least one of the electric insulating materials of above item (1) to (5).

(7) An electric insulating wire comprising the electric insulating coating compound of above item (6) and a conductor, wherein the electric insulating wire made by coating and baking of said electric insulating coating compound on the conductor.

### Effects of the Invention

According to the present invention, there are the following advantages. According to the present invention, as described in above item (1), when said polyamideimide resin comprised of the polyamideimide resin having the repeating unit of 4,4′-stilbenedicarbonate group, the electric insulating material included said polyamideimide resin can be obtained excellent thermal conduction performance (high thermal conductivity) and the above object can be achieved.

According to the present invention, as described in above item (2), as the polyamide-imide resin having the repeating unit of the 4,4′-stilbenedicarbonate group according to the above item (1), specially, when said polyamideimide resin comprised of the polyamideimide resin expressed by a following general formula (I), it is possible to obtain an excellent electrical insulating material which is even more excellent in thermal conduction performance (high thermal conductivity) and can achieve the above object.

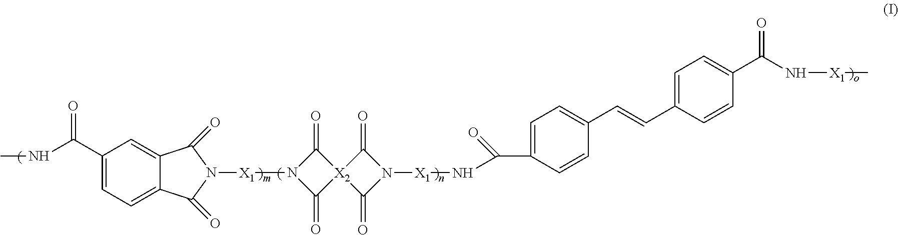

In the general formula (I), m, n, and o represent each number of the repeating unit, m is 0 or 1 to 95, n is 1 to 50, and o is 1 to 80.

X₁ and X₂ of the general formula (I) represent each at least one structural formula selected from the group consisting of the structural formula (II) to the structural formula (XVI), R of said structural formulas (IV), (XII) and (XVI) represents a hydrocarbon group.

According to the present invention, as described in above item (3), by making the polyamideimide resin is a powdered polyamideimide resin, the polyamideimide resin can be further improved in thermal conduction performance (thermal conductivity) and exhibit excellent action and effect by making it into a powder form.

According to the present invention, as described in above item (4), by making said electric insulating material composed of the polyamideimide resin added powdered ceramics, the electric insulating material can be further improved in thermal conduction performance (thermal conductivity) and exhibit excellent action and effect by making it into a powder form.

According to the present invention, as described in above item (5), by making said electric insulating material composed of the polyamideimide resin added the ceramic powder, and said ceramic powder is at least one selected from the group consisting of boron nitride, silicon carbide, aluminum nitride and aluminum oxide, the electric insulating material can be further improved in thermal conduction performance (thermal conductivity) and exhibit excellent action and effect.

According to the present invention, as described in the above item (6), by forming an electric insulating coating compound comprising at least one of an electric insulating material of above item (1) to (5), the electric insulating coating compound is not only excellent in thermal conduction performance (thermal conductivity), but also it is excellent in heat resistance, etc.

According to the present invention, as described in the above item (7), by forming an electrically insulated electric wire by coating and baking the electric insulation coating composition on the conductor, the electrically insulated electric wire is not only excellent in thermal conduction performance (thermal conductivity), but also it is excellent in heat resistance, etc.

### BEST MODE FOR CARRYING OUT THE INVENTION

The polyamideimide resin represented by the above general formula (I) of the present invention particularly has a repeating unit of a 4,4′-stilbenedicarbonate group. Optimally, the polyamideimide resin represented of the present invention has a repeating unit of an amide bond of 4,4′-stilbenedicarboxylic acid amide and a repeating unit of imide bond of tetracarboxylic anhydride.

Particularly, said repeating unit of 4,4′-stilbenedicarbonate group exerts an action effect with excellent thermal conduction performance (thermal conductivity).

In the general formula (I), m, n and o each represent the number (integer) of the repeating units, m is 0 or 1-95, n is 1-50 and o is an integer of 1-80.

As preferable examples, m is 0 or 1 to 75, n is 5 to 50, o is 20 to 80, more preferably m is 0, n is 20 to 50, o is 50 to 80, more preferably m is 5-75, and n is 20-80.

If the repeating unit deviates from the range, thermal conduction performance (thermal conductivity) deteriorates or compatibility becomes poor when the resin is dissolved in a solvent.

The compound represented by the following structural formula (II) at X₁ in the general formula (I) is a residue excluding diisocyanate group of diphenylmethane diisocyanate (MDI).

It is possible to form an amide bond of 4,4′-stilbenedicarboxylic acid amide by reacting 4,4′-stilbenedicarboxylic acid with the MDI and to form an imide bond in the general formula (I).

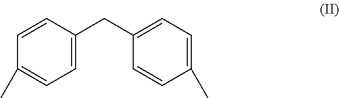

The compound represented by the following structural formula (III) in X₁ in the general formula (I) is a residue excluding diisocyanate group of diphenyl ether-4,4′-diisocyanate, the amide bond of 4,4′-stilbenedicarboxylic acid amide can be formed by the reaction of the 4,4′-stilbene dicarboxylic acid and the diisocyanate component, and an imide bond can be formed in the general formula (I).

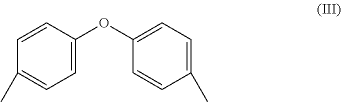

The compound represented by the following structural formula (IV) and X₁ in the general formula (I) is a residue excluding diisocyanate group of 3,3′-dimethyl-4,4′-biphenylene diisocyanate (TODD.

It is possible to form an amide bond of 4,4′-stilbenedicarboxylic acid amide by the reaction of 4,4′-stilbenedicarboxylic acid with the TODI, and to form an imide bond in the general formula (I).

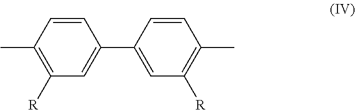

The compound represented by the following structural formula (V) and X₁ in the general formula (I) is a residue excluding diisocyanate group of 1,5-naphthalene diisocyanate (NDI).

It is possible to form an amide bond of 4,4′-stilbenedicarboxylic acid amide by reaction between 4,4′-stilbenedicarboxylic acid and the NDI, and to form an imide bond in the general formula (I).

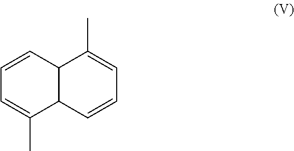

The compound represented by the following structural formula (VI) and X1 in the general formula (I) is a residue excluding diisocyanate group of m-xylidenediisocyanate (XDI, another name thereof: 1,3-bis(isocyanatomethyl) benzene).

It is possible to form an amide bond of 4,4′-stilbenedicarboxylic acid amide by reaction between 4,4′-stilbenedicarboxylic acid and the XDI, and to form an imide bond in the general formula (I).

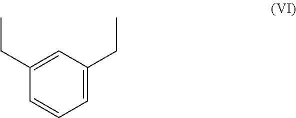

The compound represented by the following structural formula (VII) and X₁ in the general formula (I) is a residue excluding diisocyanate group of toluene diisocyanate (TDI, another name thereof: 2-methyl-m-phenylene diisocyanate).

It is possible to form an amide bond of 4,4′-stilbenedicarboxylic acid amide by reaction between 4,4′-stilbenedicarboxylic acid and the TDI, and to form an imide bond in the general formula (I).

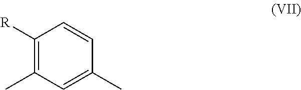

The compound represented by the following structural formula (VIII) and X₂ in the general formula (I) is a residue excluding dicarbonate group of pyromellitic anhydride (PMDA, 1,2,4,5-benzenetetracarboxylic anhydride).

An imide bond can be formed in the general formula (I).

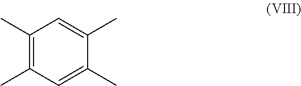

The compound represented by the following structural formula (IX) and X2 in the general formula (I) is a residue excluding dicarbonate group of 3,3′,4,4′-benzophenonetetracarboxylic dianhydride (BTDA).

An imide bond can be formed in the general formula (I).

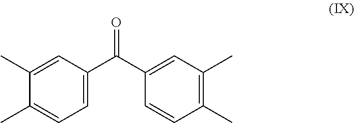

The compound represented by the following structural formula (X) and X₂ in the general formula (I) is a residue excluding dicarbonate group of bis-(3-phthalyl anhydride) ether (another name thereof: oxydiphthalicanhydride) (ODPA).

An imide bond can be formed in the general formula (I).

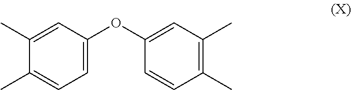

The compound represented by the following structural formula (XI) and X₂ in the general formula (I) is a residue excluding dicarbonate group of 3,3′,4,4′-diphenyl-tetracarboxylic dianhydride (BPDA).

An imide bond can be formed in the general formula (I).

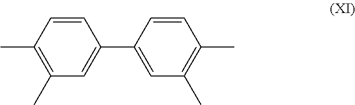

The compound represented by the following structural formula (XII) and X₂ in the general formula (I) is a residue excluding dicarbonate group of dicarbonate 2,2-bis(4-phenoxyphenyl) propanetetracarboxylic dianhydride (BPADA).

An imide bond can be formed in the general formula (I).

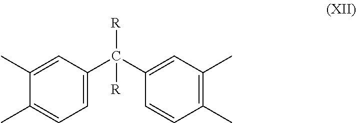

The compound represented by the following structural formula (XIII) and X₂ in the general formula (I) is a residue excluding dicarbonate group of 3,3′,4,4′-diphenyl-sulfone-tetracarboxylic-dianhydride (DSDA).

An imide bond can be formed in the general formula (I).

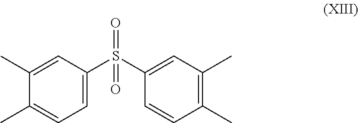

The compound represented by the following structural formula (XIV) and X₂ in the general formula (I) is a residue excluding dicarbonate group of 2,2-Bis(3-amino-4-methylphenyl)hexafluoropropane (BAPS).

An imide bond can be formed in the general formula (I).

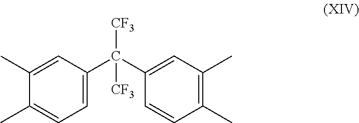

The compound represented by the following structural formula (XV) and X₂ in the general formula (I) is a residue excluding dicarbonate group of dianhydride in the form of the diether of above ODPA.

An imide bond can be formed in the general formula (I).

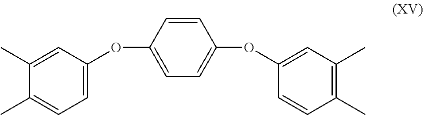

The compound represented by the following structural formula (XVI) and X₂ in the general formula (I) is a residue excluding dicarbonate group of said dianhydride.

An imide bond can be formed in the general formula (I).

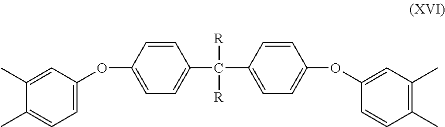

R in the above structural formulas (IV), (XII) and (XVI) represents a hydrocarbon group, as described above, but here, a methyl group is exemplified. Examples of the hydrocarbon group include, in addition to the methyl group, an alkyl group such as an ethyl group; a vinyl group; a phenyl group; an aryl group such as a naphthyl group. R of said structural formulas (VII) represent methyl group.

The 4,4′-diphenylmethane diisocyanate (MDI) represented by the structural formula (II) as X₁ in the general formula (I); diphenyl-3,3′,4,4′-tetracarboxylic dianhydride (BPDA), as a dianhydride, a structure represented by X₂ in the general formula (I) represented by the formula (XI); and the pyromellitic anhydride (PMDA, another name thereof: 1,2,4,5-Benzenetetracarboxylic anhydride) represented by the structural formula (VIII) as X₂ in the general formula (I) are used, an example of the polyamideimide resin produced by using above MDI, BPDA and PMDA is shown by the following structural formula (XVII).

In the structural formula (XVII) of the resin example, the repeating unit of m is shown in the upper stage, the repeating unit of n is shown in the middle stage, and the repeating unit of o is shown in the lower stage each separately in the structural formula (XVIII).

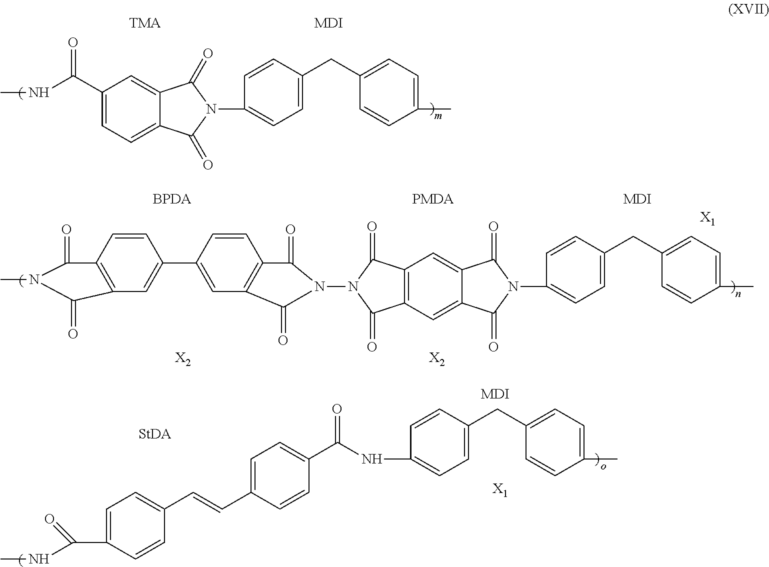

The diphenylmethane diisocyanate (MDI) represented by the structural formula (II) and X₁ in the general formula (I) is used, and as the dianhydride, pyromellitic anhydride (PMDA) represented by the a structure formula (VIII) and X₂ in the general formula (I) is used.

An example of the polyamideimide resin produced by using said MDI and said PMDA is shown by the following structural formula (XVIII).

The repeating unit of m is shown in the upper stage, the repeating unit of n in the middle stage, and the repeating unit of o in the lower stage each separately in the structural formula (XVII).

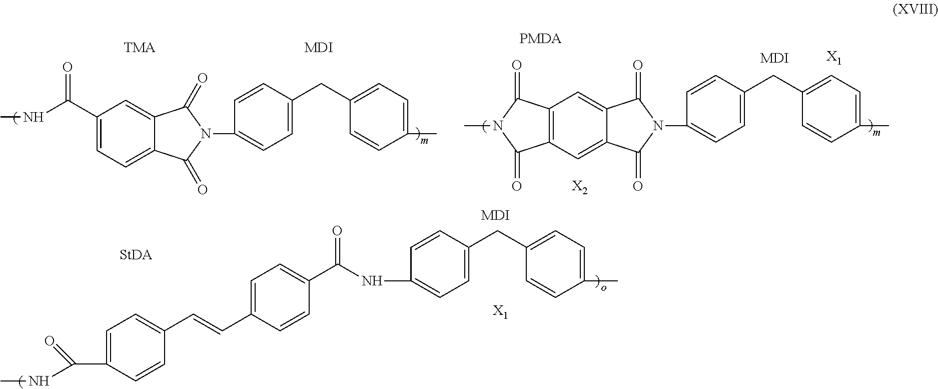

Diphenylether-4,4′-diisocyanate represented by the structural formula (III) and X₁ in the general formula (I) is used, also, as the dianhydride, a pyromellitic anhydride (PMDA) represented by the structural formula (VIII) and X₂ in the general formula (I) is used.

An example of the polyamideimide resin produced by using said diphenylether-4,4′-diisocyanate and said PMDA is shown by the following structural formula (XVIV).

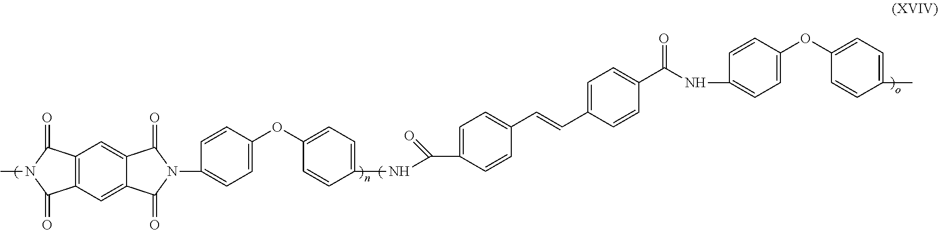

4,4′-diisocyanato-3,3′-dimethylbiphenyl (TODI) represented by the structural formula (IV) and X₁ in the general formula (I) is used, also, as the dianhydride, the pyromellitic anhydride (PMDA) represented by the structural formula (VIII) and X₂ in the general formula (I) is used.

An example of the polyamideimide resin produced by using said TODI and said PMDA is shown by the following structural formula (XX).

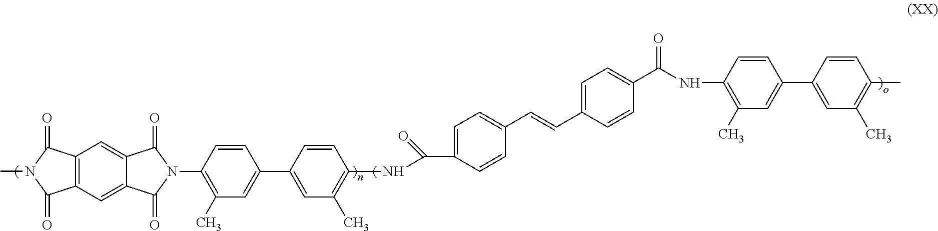

In the same manner, pyromellitic anhydride (PMDA, another name thereof: 1,2,4,5-benzenetetracarboxylic anhydride) represented by structural formula (VIII) and X₂ in the general formula (I) is commonly used, and diisocyanatonaphthalene (NDI) represented by the structure formula (V) and X₁ in the general formula (I) is used.

An example of the polyamideimide resin produced by using said PMDA and said NDI is shown by the following structural formula (XXI).

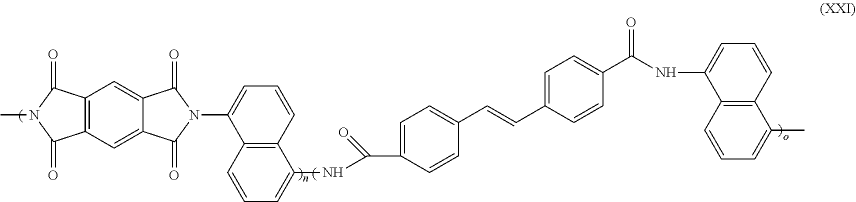

An example of the polyamideimide resin produced by using XDI (m-xylylene diisocyanate) instead of the above NDI is shown by the following structural formula (XXII).

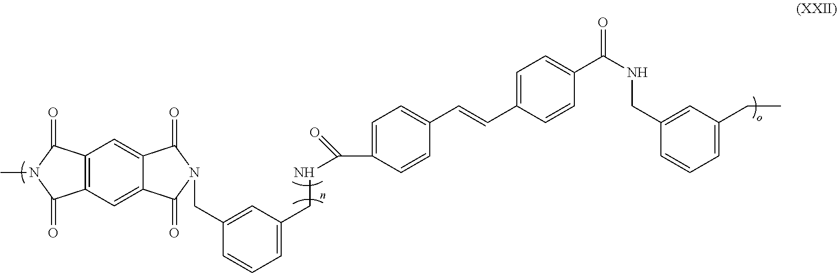

An example of the polyamideimide resin produced by using TDI (toluene diisocyanate) instead of the above XDI is shown by the following structural formula (XXIII).

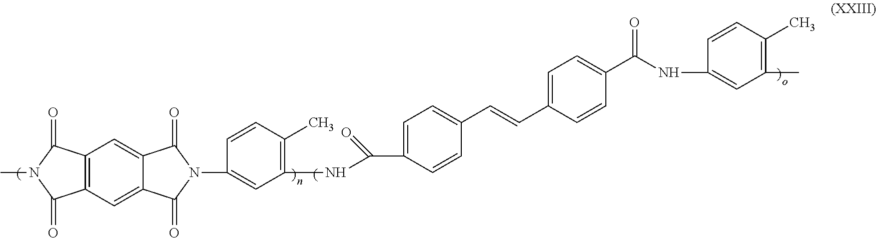

The polyamideimide resin insulating coating compound can be obtained by dissolving the polyamideimide resin represented by the general formula (I) of the present invention as a main component in the solvent components. The solvent components are not particularly limited, and examples thereof include organic solvents such as N-methylpyrrolidone, dimethylformamide, dimethylacetamide, xylene, solvent naphtha, and the like. Preferably, N-methyl-2-pyrrolidone (NMP) is preferred from the solubility of the resin and the like.

Various additives can be added to the electrically insulating coating compound.

Said additives include the crosslinking agents, lubricants and the like. Examples of the crosslinking agents include silane coupling, and the like. Examples of the lubricants include the fatty acid esters, a low molecular weight polyethylene, a wax, and the like.

As said additive agents, somewhere else, according to need, a colorant, an antioxidants (weathering agent) such as a phenolic series antioxidant, a fire retardant, and a reaction catalyst may be added.

In the case of constituting of the electrically insulating coating compound by using of the polyamideimide resin, it is preferable that the polyamideimide resin is 50% or less of the total from the viewpoints of solubility for a solvent components, thermal conductivity, electric wire physical properties, etc.

In the case of obtaining the polyamideimide resin insulating coating compound using the polyamideimide resin represented by the general formula (I) of the present invention as a main component, it is preferred that the polyamideimide resin is in the form of a powder of appropriate particles from the viewpoints of solubility for the solvent components, thermal conductivity and electric wire physical properties, etc.

In the present invention, when the electrically insulating coating compound was constituted by using a powdered polyamideimide resin, the thermal conductivity can be further improved by adding the ceramic powder to the powdery polyamideimide resin.

The ceramics is defined as “nonmetal inorganic material, which has undergone high temperature treatment in its manufacturing process”.

Among the ceramics, it include also the fine ceramics, and in Japanese Industrial Standards (JIS) 1600 (the fine ceramics related term), Fine Ceramics is defined such as follow.

“Fine Ceramics are ceramics which produced with precisely controlled chemical, compositions, microstructures, configurations and production processes to fulfill intended functions, and which are composed mainly of non-metallic, inorganic substances.”

From the viewpoint of composition, the ceramics can be classified as follows.
Element system: for example, diamond (C)
Oxide system: for example, alumina (Al₂O₃), zirconia
Hydroxide system: for example, hydroxyapatite
Carbides system: for example, silicon carbide (SiC)
Nitride system: for example, silicon nitride
Halide system: for example, fluorite

Besides, carbonates system, phosphates system

Major fine ceramics include barium titanate, ferrite, lead zirconate titanate, silicon carbide, silicon nitride, steatite (MgOSiO₂), zinc oxide, zirconia, and the like.

In the present invention, when ceramics powder is used, thermal conductivity can be further improved by adding boron nitride, silicone carbide, aluminum nitride, or aluminum oxide to the ceramic powder.

In the present invention, the proportion range of the dianhydride such as PMDA, etc. and 4,4′-stilbenedicarbonate in the blending composition influences against the solubility of the resin; the thermal conductivity as an electrically insulating material; the performance of the coating film and the electric wire characteristics. The ratio of the 4,4′-stilbenedicarbonate in the blending composition is preferably 0.2 to 0.35. The ratio of the dianhydride in the blending composition is preferably 0.15 to 0.3.

In the present invention, a suitable solid content in the case of dissolving the polyamideimide resin represented by the general formula (I) as a main component to obtain a polyamideimide resin insulating coating compound is preferably 20% to 30% by weight in view of the solubility of the resin, thermal conductivity and electric wire characteristics.

In the present invention, the electrically insulated electric wire can be constituted by coating and baking the above electrically insulating coating compound on a conductor.

The electrically insulated electric wire (magnet wire) can be constituted, by coating of the electrically insulating coating compound to the conductor (conductive wire) such as a copper, and by baking in a baking oven.

### EXAMPLES

Hereinafter, examples will be described for providing a more detailed understanding of the present invention. Needless to say, the present invention is not limited to only the following examples.

### Example 1

As shown in Table 1, in molar ratio,

4,4′-stilbene dicarboxylic acid amide (StDA) 0.2

Diphenyl-3,3′,4,4′-tetracarboxylic dianhydride (BPDA) 0.1

Pyromellitic anhydride (PMDA) 0.1

Trimellitic anhydride (TMA) 0.6

and diphenylmethane diisocyanate (MDI) 1.0

are used. Each material was dissolved in N-methyl-2-pyrrolidone (NMP) at a compounding concentration of 25%, it was held at 80 degree C. for 1 hour, then it was heated at 120 degree C. for 2 hours and at 170 degree C. for 2 hours, after the polyamideimide resin coating compound (varnish) was produced.

The resin content concentration was 23.4%. The viscosity of the polyamideimide resin coating compound was 42.9 dPa·s (at 30 degree C.). The state of the coating compound was satisfactory without precipitation of precipitates, and the like. The k value was 0.36 W/(m·K).

### Example 2

As shown in Table 1, in molar ratio,

4,4′-stilbene dicarboxylic acid amide (StDA) 0.2

3,3′,4,4′-biphenyltetracarboxylic anhydride (BPDA) 0.1

Trimellitic anhydride (TMA) 0.7

and diphenylmethane diisocyanate (MDI) 1.0

are used. Each material was dissolved in N-methyl-2-pyrrolidone (NMP) at a compounding concentration of 25%, and a polyamideimide resin coating compound was produced in the same manner as in Example 1. The viscosity was 23.2 dPa·s (at 30 degree C.). The state of the coating compound was satisfactory without precipitation of precipitates, and the like.

### Example 3

As shown in Table 1, in molar ratio,

4,4′-stilbene dicarboxylic acid amide (StDA) 0.3

3,3′,4,4′-biphenyltetracarboxylic anhydride (BPDA) 0.2

Trimellitic anhydride (TMA) 0.5

and diphenylmethane diisocyanate (MDI) 1.0

are used, each material was dissolved in N-methyl-2-pyrrolidone (NMP) at a compounding concentration of 25%, and the polyamideimide resin coating compound was produced in the same manner as in Example 1. The viscosity was 18.3 dPa·s (at 30 degree C.). The state of the polyamideimide resin coating compound was satisfactory without precipitation of precipitates, and the like.

### Example 4

As shown in Table 1, in molar ratio,

4,4′-stilbene dicarboxylic acid amide (StDA) 0.35

3,3′,4,4′-biphenyltetracarboxylic anhydride (BPDA) 0.15

Trimellitic anhydride (TMA) 0.5

and diphenylmethane diisocyanate (MDI) 1.0

are used, each material was dissolved in N-methyl-2-pyrrolidone (NMP) at a compounding concentration of 25%, and the polyamideimide resin coating compound was produced in the same manner as in Example 1. The viscosity of the polyamideimide resin coating compound was 18.3 dPa·s (at 30 degree C.). The state of the polyamideimide resin coating compound was satisfactory without precipitation of precipitates, and the like.

### Example 5

As shown in Table 1, in molar ratio,

4,4′-stilbene dicarboxylic acid amide (StDA) 0.3

4,4′-oxydiphthalic anhydride (ODPA) 0.2

Trimellitic anhydride (TMA) 0.5

and diphenylmethane diisocyanate (MDI) 1.0

are used, each material was dissolved in N-methyl-2-pyrrolidone (NMP) at a compounding concentration of 25%, and the polyamideimide resin coating compound was produced in the same manner as in Example 1. The viscosity of the polyamideimide resin coating compound was 8.1 dPa·s (at 30 degree C.). The state of the polyamideimide resin coating compound was satisfactory without precipitation of precipitates, and the like.

The electric insulating wire made by using the polyamideimide resins coating compound obtained from the above examples.

Structure and Specification of Electric Insulating Wires:

The electric insulating wires were manufactured by the following specification as shown in Table 2 and Table 3.

(I) Baking furnace (used a horizontal electric heat furnace)
(a) The drawing method: dice, and the number of times to drawing: 8 times
(b) Baking temperature (degrees C.):
   annealing temperature 550 degrees temperature (degrees C.) of a furnace: inlet temperature 450 degree C.-outlet temperature 500 degree C.,
(c) Linear velocity: 20 m/min.
(d) Conducting wire radial: 0.45 mm
(e) Coating thickness: 0.023 mm

(II) Baking furnace (used a vertical electric heat furnace)
(a) The drawing method: dice.
(b) Baking temperature (degrees C.):
   Bottom 370° C.-Medium 450° C.-Upper 500° C.
(c) Linear velocity: 18 m/min., 20 m/min. and 22 m/min.
(d) Conducting wire radial: 1.00 mm
(e) wire radial: 1.067-1.069 mm
(f) Coating thickness: 0.034 mm

In Table 3, the electrically insulated electric wire used the polyamideimide resin coating compound (varnish) obtained in Example 1 was shown as sample name MstBP25211.

With respect to the polyamideimide resin coating compound obtained as described above, the thermal conductivity was evaluated in accordance with the following measuring method.

Measurement of Thermal Conductivity:

Evaluation of thermal conductivity performance can be made by measuring thermal conductivity. The thermal conductivity is a physical quantity defining the magnitude of the heat flux carried along the gradient in the case where there is a temperature gradient in the medium in thermal conduction and is also called heat conduction.

Assuming that the heat flux is J, the temperature is T, and the temperature gradient is grad T, the thermal conductivity λ is defined as the proportional coefficient of Fourier's law: J=−λgrad T. SI unit is watt per meter per Kelvin W/(m·K). As a symbol of thermal conductivity, k is used in addition to λ. K value (W/(m·K)) was measured according to ASTM D5470-06.

Table 1 shows the k value (W/(m·K)) for the polyamideimide resin coating compound obtained as described above. The k value is about 0.23 W/(m·K) for ordinary polyamide imide resin, and when it shows 0.3 W/(m·K) or more, it is evaluated that it has excellent thermal conductivity. In Table 1, the physical property results of the coating film are also shown.

Recognition of Characteristic of the Electric Insulating Wire:

The recognition of characteristic of the electric insulating wire was carried by the following recognition method of characteristic of the electric insulating wire.

(a) Breakdown voltage;
Insulating breakdown voltage (kV) was measured based on Japanese Industrial Standards (JIS) C 3216-4.

(b) Heat shock (1);
The number of cracks after heat treatment at 220 degrees C. and 0.5 hour by NEMA method was measured. Also, the number of pinhole was measured.

(c) Heat shock (2);
The number of cracks after heat treatment at 240 degrees C. and 1 hour was measured.

(d) Flexibility;
It was measured at 1 d (diameter of self). Also, the number of cracks of pinhole of 1 d diameter, 2 d diameter and 3 d diameter at the times of 20% extension winding was measured.

(e) Heat softening resistance;
It was measured at load 500 g. The average number (degrees C.) calculates.

(f) Glass transition temperature (Tg);
Tg (tan δ) (degrees C.) was measured based on the heater method and the metal passing method.

The results are shown in Table 2 and 3.

### Comparative Example 1

General purpose polyamide imide resin (general purpose Al) not having amide bond of 4,4′-stilbene dicarboxylic acid amide was used without using 4,4′-stilbene dicarboxylic acid amide (StDA) as in the present invention, by the same manner as in Example 1, the polyamideimide resin coating compound was produced. Similarly, when the k value was measured, the k value was 0.23 W/(m·K) by the same manner as in Example 1. The insulated electric wire was formed using the horizontal electric heat furnace, and the electric wire characteristics were measured by the same electric wire characteristic evaluation method as in the above example, and the results are shown in Table 2.

TABLE 1

| | |
|---|---|
| compounding | example No. |

| materials | 1 | 2 | 3 | 4 | 5 |
|---|---|---|---|---|---|
| StDA | 0.2 | 0.2 | 0.3 | 0.35 | 0.3 |
| BPDA | 0.1 | 0.1 | 0.2 | 0.15 | 0 |
| PMDA | 0.1 | 0 | 0 | 0 | 0 |
| ODPA | 0 | 0 | 0 | 0 | 0.2 |
| TMA | 0.6 | 0.7 | 0.5 | 0.5 | 0.5 |
| MDI | 1.0 | 1.0 | 1.0 | 1.0 | 1.0 |
| compouding density | 25% | 25% | 25% | 25% | 25% |
| varnish condition | good | good | good | good | good |
| varnish physicality | 42.9 | 23.2 | 18.3 | 18.3 | 8.1 |
| (viscosity dPa · s | | | | | |
| at 30degree) | | | | | |
| kvalue | 0.36 | 0.35 | 0.36 | 0.36 | 0.32 |

TABLE 2

| | | | Sample name | | | |
|---|---|---|---|---|---|---|
| | | | Product of present | | | |
| | | | invention | | General AI | |
| Baking furnace | | | Horizontal electric heat furnace | | | |
| Drawing method | | | Dice drawing-times 8 | | | |
| Baking temp. | | dgree C. | annealing: 550 degree C. | | | |
| | | | temp. of furnace | | | |
| | | | inlet450-outlet | | | |
| | | | 500 dergee C. | | | |
| Linear velocity | | m/min | 20 | | 20 | |
| Conducting wire radial | | mm | 0.45 | | | |
| wire radial | | mm | 0.495 to | | 0.500 to | |
| | | | 0.497 | | 0.502 | |
| Coating thickness | | mm | 0.023 | | 0.026 | |
| Breakdown voltage | | kv | 7.59 | | 13.23 | |
| (B.D.V) | | | | | | |
| NEMA Heat shock | | 1 d | 4 | 3 | 0 | 0 |
| 220 dgree C. 0.5 hour | | 2 d | 0 | 0 | 0 | 0 |
| left: cracks number | | 3 d | 0 | 0 | 0 | 0 |
| right: pinhole number | | | | | | |
| Heat shock | | 1 d | 0 | 0 | 0 | 0 |
| 240 dgree C. 1 hour | | 2 d | 0 | 0 | 0 | 0 |
| number of cracks | | 3 d | 0 | 0 | 0 | 0 |
| Flexibilyty | non | 1 d | 0 | 0 | 0 | 0 |
| | extention | | | | | |
| | 20% | 1 d | 3 | 4 | 0 | 0 |
| | extntion | 2 d | 0 | 0 | 0 | 0 |
| | | 3 d | 0 | 0 | 0 | 0 |

| | | | |
|---|---|---|---|
| Heat softening | average | 449 | 505 |
| resistance load 500 g | dgree C. | | |
| Tandelta degree C. | heater | 252 | 293 |

TABLE 3

| Sample name | | | MStBP25211 | | | | | |
|---|---|---|---|---|---|---|---|---|
| Baking furnace | | | Vertical electric heat furnace | | | | | |
| Drawing method | | | Dice | | | | | |
| Baking temp. | | dgree C. | annealing: 550 degree C. | | | | | |
| | | | bottom 370 dgree C. | | | | | |
| | | | medium 450 dgree C. | | | | | |
| | | | top 500 dgree C. | | | | | |
| Linear velocity | | m/min | 18 | | 20 | | 22 | |
| appearance | | visual | good | | good | | good | |
| Conducting wire radial | | mm | 1.00 | | | | | |
| wire radial | | mm | 1.067 to | | 1.067 to | | 1.067 to | |
| | | | 1.069 | | 1.069 | | 1.069 | |
| Coating thickness | | mm | 0.034 | | 0.034 | | 0.034 | |
| Breakdown voltage | | kv | 7.50 | | 7.63 | | 7.43 | |
| (B.D.V) | | | | | | | | |
| NEMA Heat shock | | 1 d | 3 | 3 | 2 | 2 | 3 | 3 |
| 220 dgree C. 1 hour | | 2 d | 1 | 1 | 0 | 0 | 0 | 0 |
| left: cracks number | | 3 d | 0 | 0 | 0 | 0 | 0 | 0 |
| right: pinhole number | | | | | | | | |
| Heat shock | | 1 d | 0 | 0 | 0 | 0 | 4 | 4 |
| 240 dgree C. 1 hour | | 2 d | 0 | 0 | 0 | 0 | 0 | 0 |
| number of cracks | | 3 d | 0 | 0 | 0 | 0 | 0 | 0 |
| Flexibilyty | non extention | 1 d | 0 | 0 | 0 | 0 | | 4 |
| | | 2 d | 0 | 0 | 0 | 0 | 0 | 0 |
| | | 3 d | 0 | 0 | 0 | 0 | 0 | 0 |
| | 20% extntion | 1 d | 0 | 0 | 1 | 2 | 1 | 2 |

| | | | | |
|---|---|---|---|---|
| Heat softening | average | 460 | 430 | 410 |
| resistance load 500 g | dgree C. | | | |
| Tandelta degree C. | heater | 259 | 226 | 214 |

### Result

As shown in Table 1, in the present invention, the thermal conductivity k value is 0.32-0.36 W/(m·K), consequently, the thermal conductivity k value shows more than 0.3 W/(m·K), in ordinary polyamideimide resin, the thermal conductivity k value is about 0.23 W/(m·K), therefore, it show that thermal conductivity was excellent in the evaluation of thermal conductivity. In addition, as shown in Table 1, the physical property result of the coating film was also good. In the evaluation of the electric wire, the product of the present invention has a weakness in the self diameter of the heat shock (1) by the NEMA method as compared with the general-purpose comparative product, and the softening temperature and the glass transition temperature (Tg) are lowered from the introduction of the amide bond of the 4,4′-stilbenedicarboxylic acid amide, however it is excellent in the above thermal conductivity and can be sufficiently supplemented.

### INDUSTRIAL APPLICABILITY

The present invention can be applied to electric insulating coating compound and electric insulating wire, additionally, the present invention can be applied to various electrical insulating materials such as an adhesive, etc., requiring electrical insulation performance.

The present invention can be widely applied to other polyamideimide resin in addition to the polyamideimide resin represented by the general formula (I) in the above Example, as long as it has a repeating unit of 4,4′-stilbene dicarbonate group.

The polyamideimide resin of the present invention can be obtained by reacting 4,4′-stilbene dicarboxylic acid, a diisocyanate component, an acid component, and other necessary components such as other amine components.

At that time, as a diisocyanate component, it can be also applied to some other diisocyanate components than those represented by the structural formula of X1.

For example, some other aliphatic diisocyanates, such as hexamethylene diisocyanate (HDI), isophorone diisocyanate (IPDI), hydrogenated xylylene diisocyanate (XDI): and diphenyl sulfone diisocyanate (SDI) of aromatic diisocyanates and the like, can be used.

Further, as such some other isocyanate components, a polyfunctional isocyanate such as triphenylmethane triisocyanate; a polymeric isocyanate; a multimer such as TDI and the like can be used, and isomers of TDI and MDI may be included.

Further, as the acid component, it can be also applied to some other acid components than those represented by the structural formula of X2.

As the acid component, it can be also applied to other tetracarboxylic acids: butanetetracarboxylic dianhydride: and alicyclic tetracarboxylic acid dianhydride such as 5-(2,5-dioxotetrahydro-3-furanyl)-3-methyl-3-cyclohexene-1,2-dicarboxylic anhydride and the like: than those represented by the structural formula of X2.

Also, it can be also applied to a tricarboxylic acid such as trimesic acid or tris(2-carboxyethyl) isocyanurate (CIC acid) for example.

Further, although R in the above structural formulas (IV), (XII) and (XVI) represents a hydrocarbon group, R can be broadly applied to a functional group such as a carbonyl group, a nitro group, a carboxy group, an amino group, a sulfo group, an ether bond, an ester bond, a hydroxyl group, and an aldehyde group, also, R can be broadly applied to a substituent including a functional group, and the like.

In the present invention, if the resins have a repeating unit of 4,4′-stilbenedicarbonate group, the resins are likewise possible to use for a polyester imide resin and the like having a repeating unit of 4,4′-stilbenedicarbonate group.

The polyesterimide resin can be obtained by reacting, 4,4′-stilbenedicarboxylic acid, a diamine component, and an acid component such as a tetracarboxylic acid dianhydride.

1. An electric insulating material comprising a polyamideimide resin having a repeating unit of 4,4′-stilbenedicarbonate group.

2. The electric insulating material according to claim 1, wherein the polyamideimide resin is a polyamideimide resin expressed by a following general formula (I), 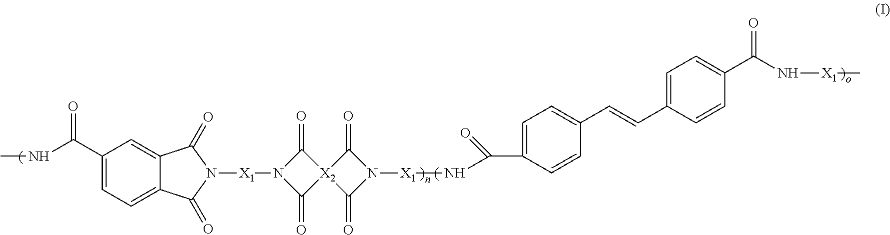
wherein m, n, and o of in the general formula (I) represent each number of the repeating unit, m is 0 or 1 to 95, n is 1 to 50, and o is 1 to 80,
wherein plural X₁ of the general formula (I) represent each independently at least one structural formula selected from the group consisting of a following structural formula (II), a following structural formula (III), a following structural formula (IV), a following structural formula (V), a following structural formula (VI), and a following structural formula (VII), 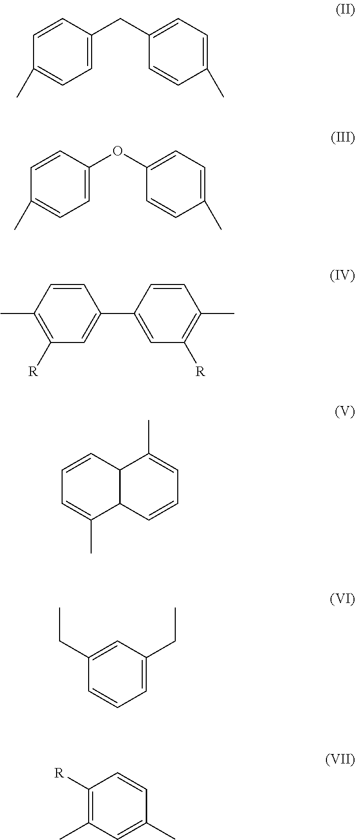
wherein plural X₂ in the general formula (I) represents each independently at least one structural formula selected from the group consisting of a following structural formula (VIII), a following structural formula (IX), a following structural formula (X), a following structural formula (XI), a following structural formula (XII), a following structural formula (XIII), a following structural formula (XIV), a following structural formula (XV), and a following structural formula (XVI), 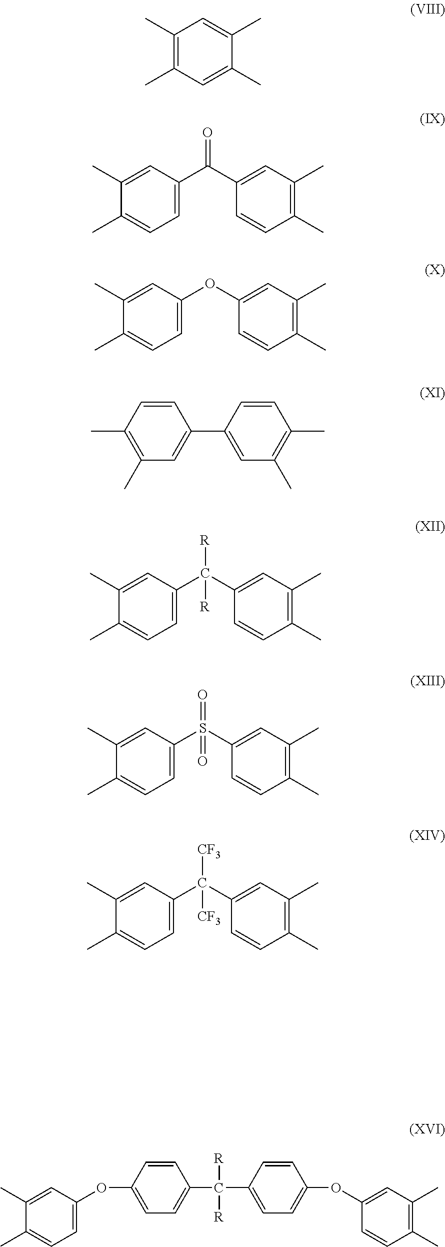
wherein R of said structural formulas (IV), (XII), and (XVI) represent a hydrocarbon group.

3. The electric insulating material according to claim 1, wherein the polyamideimide resin is a powdered polyamideimide resin.

4. The electric insulating material according to claim 3, further comprising the polyamideimide resin added a ceramic powder.

5. The electric insulating material according to claim 3, further comprising the
polyamideimide resin added boron nitride, silicon carbide, aluminum nitride, or aluminum oxide.

6. An electric insulating coating compound comprising at least one of the electric insulating materials of claim 1.

7. An electric insulating wire comprising the electric insulating coating compound of claim 6 and a conductor, wherein the electric insulating wire made by coating and baking of said electric insulating coating compound to the conductor.
